(19) United States
(12) Patent Application Publication
(10) Pub. No.: US 2006/0281832 A1
(43) Pub. Date: Dec. 14, 2006

(54) Manipulation of topological characteristics of bulk polymerized poly(alpha-olefins) via reaction variables and conditions to enhance dissolution of drag reducing polymers

(75) Inventor: Jeffery R. Harris, Tulsa, OK (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/446,920

(22) Filed: Jun. 5, 2006

Related U.S. Application Data
(60) Provisional application No. 60/689,839, filed on Jun. 13, 2005.

(51) Int. Cl. C09K 3/00

(52) U.S. Cl. 523/175

(57) ABSTRACT

The dissolution of polymeric drag reducing agents (DRAs) in flowing hydrocarbon fluids is improved by incorporating branching into the polymer DRAs. A branched polymer of the same molecular weight will have a smaller overall size because of its reduced radius of gyration (Rg), and thus dissolve more readily. In one non-limiting embodiment, the polymer is a poly(alpha-olefin) and the branches are long-chain branches (Y-branching) and/or induced or H-branching, whereby the induced branch length may have an average chain length of at least 4-8 carbon atoms.

### CROSS-REFERENCE TO RELATED APPLICATION

This application claims the benefit of U.S. Provisional Application No. 60/689,839 filed Jun. 13, 2005.

### TECHNICAL FIELD

The invention relates to processes for producing and using polymeric drag reducing agents, and most particularly to processes for providing and using polymeric drag reducing agents that have improved dissolution in the hydrocarbons into which they are introduced.

### TECHNICAL BACKGROUND

The use of polyalpha-olefins or copolymers thereof to reduce the drag of a hydrocarbon flowing through a conduit, and hence the energy requirements for such fluid hydrocarbon transportation, is well known. These drag reducing agents or DRAs have taken various forms in the past, including slurries or dispersions of ground polymers to form free-flowing and pumpable mixtures in liquid media. A problem generally experienced with simply grinding the polyalpha-olefins (PAOs) is that the particles will “cold flow” or stick together into a relatively large, intractable mass after the passage of time, thus making it impossible to place the PAO in the hydrocarbon where drag is to be reduced, in a form of suitable surface area, and thus particle size, that will dissolve or otherwise mix with the hydrocarbon in an efficient manner. Further, the grinding process or mechanical work employed in size reduction tends to degrade the polymer, thereby reducing the drag reduction efficiency of the polymer.

One common solution to preventing cold flow is to coat the ground polymer particles with an anti-agglomerating or partitioning agent. Cryogenic grinding of the polymers to produce the particles prior to or simultaneously with coating with an anti-agglomerating agent has also been used. However, some powdered or particulate DRA slurries require special equipment for preparation, storage and injection into a conduit to ensure that the DRA is completely dissolved in the hydrocarbon stream. The formulation science that provides a dispersion of suitable stability such that it will remain in a pumpable form necessitates this special equipment.

Gel or solution DRAs (those polymers essentially being in a viscous solution with hydrocarbon solvent) have also been tried in the past. However, these drag reducing gels also demand specialized injection equipment, as well as pressurized delivery systems. The gels or the solution DRAs are stable and have a defined set of conditions that have to be met by mechanical equipment to pump them, including, but not necessarily limited to viscosity, vapor pressure, undesirable degradation due to shear, etc. The gel or solution DRAs are also limited to about 10% polymer as a maximum concentration in a solvent due to the high solution viscosity of these DRAs. Thus, transportation costs of some conventional DRAs are considerable, since up to about 90% of the volume being transported and handled is inert material.

Furthermore, once the polymer DRA is delivered to a hydrocarbon stream, it may take some considerable time to dissolve and become effective. Because useful DRAs are relatively high molecular weight polymers, it requires appreciable time and/or distance for dissolution and mixing into the flowing stream.

From reviewing the many prior patents it can be appreciated that considerable resources have been spent on both chemical and physical techniques for easily and effectively delivering drag reducing agents to the fluid that will have its drag or friction reduced. Yet none of these prior methods has proven entirely satisfactory. Thus, it would be desirable if a drag reducing agent could be developed which rapidly dissolves in the flowing hydrocarbon, which could minimize or eliminate the need for special equipment for preparation and incorporation into the hydrocarbon

### SUMMARY

There is provided, in one non-limiting form, a process for forming polymer drag reducing agents (DRAs) having improved dissolution in a hydrocarbon. The process involves polymerizing an alpha-olefin monomer in the presence of a catalyst to form a polymer. Branching is introduced into the polymer during polymerization by a technique including, but not necessarily limited to, (1) increasing beta-hydride elimination, (2) incorporating a di-functional or di-unsaturated monomer with the alpha-olefin monomer; (3) incorporating a catalyst that causes branching; and a combination of these techniques. Increasing beta-hydride elimination may occur by a method including, but not necessarily limited to, (a) decreasing monomer concentration; (b) increasing polymerization temperature; and a combination thereof.

In an alternate non-limiting embodiment, there is provided a bulk poly(alpha-olefin) DRA with induced long-chain branching, where the agent has improved dissolution in a hydrocarbon as compared with a linear poly(alpha-olefin) DRA of identical molecular weight absent the branches. In one non-limiting embodiment long-chain branching is defined as branching which results from addition of an unsaturated carbon-carbon end group in a terminated polymer chain end, to the active chain end of another growing chain. This point of chain end unsaturation and subsequent branching is created by the natural process of Ziegler-Natta catalyst polymerization kinetics and would be analogous to the alphabetical letter Y in terms of molecular shape. In another non-restrictive embodiment, there is provided a poly(alpha-olefin) drag reducing agent with long-chain branching defined by Y-branching, where the drag reducing agent has improved dissolution in a hydrocarbon as compared with a linear poly(alpha-olefin) drag reducing agent of identical molecular weight absent the Y branches. In one non-limiting embodiment, the long-chain branching is defined herein as having greater than 50 carbon atoms, and in an alternate, non-restrictive version may have at least 20 carbon atoms.

In another non-limiting embodiment, there is offered a fluid having reduced drag that includes a hydrocarbon fluid, and a poly(alpha-olefin) DRA with induced H-branching. H-branching is defined herein as that shorter branch between long polymer chains taking an analogous molecular shape to the alphabetical letter H. In one non-limiting embodiment, the additional component added to the polymerization to induce H-branching, i.e. the di-unsaturated monomer, may be between 4-12 carbon atoms. As will be further discussed, the polymer DRAs herein may have only V-branching, only H-branching or a combination of the two.

In another non-restrictive embodiment, there is provided a bulk polymer DRA incorporating a catalyst that causes branching, e.g. long-chain Y-branching, and in combination with additional induced H-branching, also offers increased resistance to fluid shearing forces.

### BRIEF DESCRIPTION OF THE DRAWINGS

FIG. 1 is a graph of the percent drag reduction of various bulk-polymerized polyoctene (C8) polymers in diesel fuel as a function of time using various hexadiene systems compared to controls;

FIG. 2 is a graph of the dissolution behavior of hexene/dodecene copolymers in kerosene; copolymer controls are shown, also copolymers modified with 500 ppm 1,5-hexadiene;

FIG. 3 is a graph of the dissolution behavior of hexene/dodecene copolymers in kerosene; copolymer controls are shown, also copolymers modified with 1000 ppm 1,5-hexadiene;

FIG. 4 is a graph of the dissolution behavior of hexene/dodecene copolymers in kerosene; copolymer controls are shown, also copolymers modified with 2000 ppm 1,5-hexadiene;

FIG. 5 is a graph of the dissolution behavior of polyoctene in kerosene vs. polyoctene modified with 2000 ppm 1,5-hexadiene; and

FIG. 6 is a graph of the dissolution behavior of polydecene in kerosene vs. polydecene modified with 2000 ppm 1,5-hexadiene.

### DETAILED DESCRIPTION OF THE INVENTION

The invention involves the manipulation of the topological characteristics (also known as molecular architecture) of polyolefins to refine or redefine the physical characteristics of the polymers to improve their dissolution in flowing hydrocarbons to make it easier to reduce the drag thereof with these polymers.

It has become known only in recent years that both Long-chain Branching (LCB) and Short Chain Branching (SCB) exhibit strong differences in molecular properties as compared to linear polymers in solution as well as in bulk behavioral characteristics/properties. The degree to which one finds branching in olefin polymers is a function of catalyst as well as reaction conditions such as solvent type, monomer concentration (solvent or neat polymerization methods), temperature, added components, etc.

There are numerous pathways whereby polymer branching may occur, however, one of the more common mechanisms is through beta-hydride elimination, a long established mechanism in Ziegler-Natta chemistry. Once the beta-hydride elimination occurs, a point of unsaturation is generated at the end of the polymer chain; hence the chain can be incorporated into another growing end thereby forming a comb branch in the polymer structure. This type of branching may be affected by temperature and monomer concentration, relatively more so by concentration. Thus, as monomer concentration becomes more dilute, for example solution polymerization, chain branching increases. Thus, given Ziegler-Natta kinetics, higher temperatures would also be expected to enhance the beta-hydride elimination reaction, forming corresponding amounts of chain branching.

The overall effect in chain branching of these polymers has been studied via light scattering studies. For instance, given two polymers of the same molecular weight solubilized and diluted in a good solvent, (one composed of linear polymer and the other having branching), each will have different radiuses of gyration (Rg) or size in solution (viscosity being a function of size or hydrodynamic volume of polymer in solution). The linear polymer will reach its greatest extended chain dimensions (larger Rg), whereas, the branched polymer of same molecular weight will have a smaller size in solution or (smaller Rg).

The smaller Rg for branched polymers is important for drag reduction, and particularly for the solubilization or dissolution of the polymer. For two polymers of the same molecular weight, the linear polymer will have the greatest degree of entanglements, whereas, the degree of chain entanglement in branched polymer will be decreased by the branch points of the polymer chains. Limited entanglements lead to enhanced solubility due to solvent molecules having to solvate fewer entanglements or in other words; the polymer having to unwrap itself. Put another way, the branched polymer will dissolve faster than the linear polymer although both have the same molecular weight, simply different topology.

The primary distinction herein is between linear olefin polymers to those olefin polymers with branching, both long-chain and induced H-branching. It is the branching morphology that gives rise to “points of constriction” resulting in better dissolution (i.e. fewer entangling polymer chain ends) vs. the highly entangled linear (bulk) polymers. For example, consider two polymers having the same molecular weight, one is linear and the other is branched. The branched polymer will exhibit a smaller size (relatively smaller Rg) in solution than that of its linear counterpart (of identical or similar molecular weight). The branching forms “points of constriction”, thereby disallowing the molecule to fully uncoil into its greatest extended dimensions. A highly linear polymer on the other hand will uncoil to its greatest extended dimensions (relatively larger Rg) in solution. However, the time the linear molecule takes to uncoil itself is much longer due the greater entanglement (no points of constriction to prevent high entanglement).

In one non-limiting embodiment of the invention, the branching achieved by the methods herein include, but are not necessarily limited to induced or H-branching and LCB through manipulation of reaction conditions. The chain branching achieved via the incorporation of di-unsaturated or di-functional monomers (or induced branching) is nominally referred to as H-branching. Long-chain branching (also called Y-branching herein) on the other hand may be understood as a natural condition of Ziegler-Natta catalyst systems; however, a process that can be manipulated though control/variance of temperature, monomer concentration. In one non-restrictive version, H-branching is defined herein as branching where the average branch length is at least 4-8 carbon atoms.

With respect to reaction conditions, the beta-hydride elimination reaction (LCB generation mechanism) is depressed by increased monomer concentration and lower temperature conditions. Thus, using bulk or neat reaction conditions coupled with conditions of low temperature to enhance molecular weight reduces the occurrence of branching. That is, forming very high molecular weight linear polymer leads to very high degrees of entanglement and relatively poor properties of dissolution. On the other hand, in polymerization processes where the monomer concentration is low (in one non-limiting embodiment, on the order of 12% or lower or alternatively 10% or lower) and temperatures reach higher values, the conditions are improved for branching (enhanced beta-hydride elimination rate).

However, it may be seen that when monomer concentrations are increased to 18-24%, the beta-hydride elimination or branching mechanism decreases. Thus, polymer molecular weight and linearity increases and solubility decreases. Apparently the higher monomer concentration prevails over the effects of higher temperature with respect to beta-hydride elimination in the gels.

One non-limiting technique for introducing branching is to induce branching into the bulk polymer during production. This can be accomplished by introducing small quantities (100-2000 ppm) of di-unsaturated monomer to produce some H-branching pathways giving rise to a level of branching which balances the high molecular weight with the branching needed to maintain or supply adequate solubility/dissolution (that is, retard the polymer linearity). Thus, it is not enough to simply lower molecular weight in the bulk process by increasing catalyst content (since polymer will continue to be linear and of high entanglements). Branching may be introduced to decrease/retard entanglements and enhance solubility. The drag efficiency will be lowered somewhat over the high values typically measured for bulk polymers of similar or identical molecular weight, however, one should be able to take advantage of the economics of a solvent-free process and at the same time maximize the induced branching/% drag/dissolution curve.

Acceptable solvents to be used in diluting the monomers in the polymerization reactions herein include, but are not necessarily limited to, hydrocarbon solvents inert to the catalyst systems such as kerosene, hexane, cyclohexane, pentane, isopentane, heptane and mixtures thereof.

Suitable di-functional or di-unsaturated monomers that may be used to increase branching in poly(alpha-olefins) include, but are not necessarily limited to, those monomers having at least two carbon-carbon unsaturated bonds separated by at least 2 saturated carbon atoms. In one non-limiting embodiment the dienes are not conjugated. In another non-restrictive version, the di-functional monomers are aliphatic or non-aromatic. In another specific non-limiting embodiment, the di-functional monomer excludes divinyl benzene. Specific examples of suitable di-unsaturated monomers include, but are not necessarily limited to 1,5-hexadiene, 1,7-octadiene, 1,9-decadiene, 1,11-dodecadiene, 2-methylene-5-norbornene, 5-vinyl-2-norbornene, dicyclopentadiene and the like and mixtures thereof. Trifunctional or higher monomers may be useful in small quantities, as long as undesirable crosslinking and gelling is substantially prevented.

In one non-limiting embodiment herein the amount of di-unsaturated monomer used, as a percent of the total monomer, may be less than 0.0001% or alternatively about 0.4% or less; in another non-restrictive version, about 0.1% or less.

In yet a different non-limiting embodiment herein, when the technique employed to introduce branching is incorporating a di-unsaturated monomer along with the alpha-olefin monomer, the catalyst is preferably not a polymerization catalyst comprising a Group 4-6 (IUPAC 1990) transition metal compound and an organo-aluminium compound, characterized in that said transition metal compound has been prepared by providing a support comprising an atomized complex of a magnesium halide and a monohydric C1-C4 alcohol and contacting the support with a halogenous titanium compound and a C6-C8 alkyl carboxylic acid ester under conditions which deposit the halogenous titanium compound on the support and cause transesterification between the monohydric C1-C4 alcohol and the C6-C18 alkyl carboxylic acid ester.

Particular catalysts which are known to increase the branching content of poly(alpha-olefins) include, but are not necessarily limited to typical Ziegler-Natta catalysts pre-activated by the addition of di-functional or multi-functional monomers leading to a star-shaped initiating site or points of chain growth and the like.

Relatively increased polymerization temperatures may be in the range of between about between about 0 and about 70° C. In another non-restrictive embodiment, the lower end of the temperature range may be about 0° C. and independently the upper end of the temperature range may be about 50° C. As noted, reaction temperature needs to be balanced with monomer concentration and ultimate polymer molecular weight to give a product with good drag reduction properties as well as branching to improve its dissolution in hydrocarbon. It will be appreciated that a combination of techniques may be utilized to optimize H-branching and LCB giving rise to a poly(alpha-olefin) having improved dissolution ability as well as excellent drag reducing capability.

A range of experiments may be devised such that the inclusion of small quantities of multi- or di-unsaturated monomers will produce a series of polymer branches further enhancing the solubility/dissolution and performance of bulk polymerized polymers in fuel and petroleum pipelines.

Quantization or describing branching via absolute analytical techniques may be difficult. Laboratory experimentation utilizing both dissolution and shear information may help guide research efforts.

The invention will now be discussed with respect to various Examples which are not intended to limit the invention, but simply to further illuminate and expand upon it.

### EXAMPLE 1

Preliminary polymerization experiments were conducted in sealable culture tubes submerged in a cold bath. Thus, in each case known quantities of monomer and or di-functional monomer were deposited in a culture tube, the tube sealed and subsequently purged with nitrogen. Upon cooling the tubes and monomer to 25° F. (−3.9° C.), both aluminum alkyl and titanium trichloride (dispersed in mineral oil) were injected into each tube via syringe. Stirring was accomplished by Teflon® coated magnetic stirring bars in the bottom of the tubes. Once the catalyst-activated monomer reached sufficient viscosity such that the stir bar was prohibited from stirring, the tubes were transferred to a refrigerator freezer where polymerization continued for 24 hours. Upon recovery the bulk polymers were granulated and ground to fine particle sizes utilizing a laboratory colloid mill. Dissolution studies were conducted on each polymer and that data can be found in Table I.

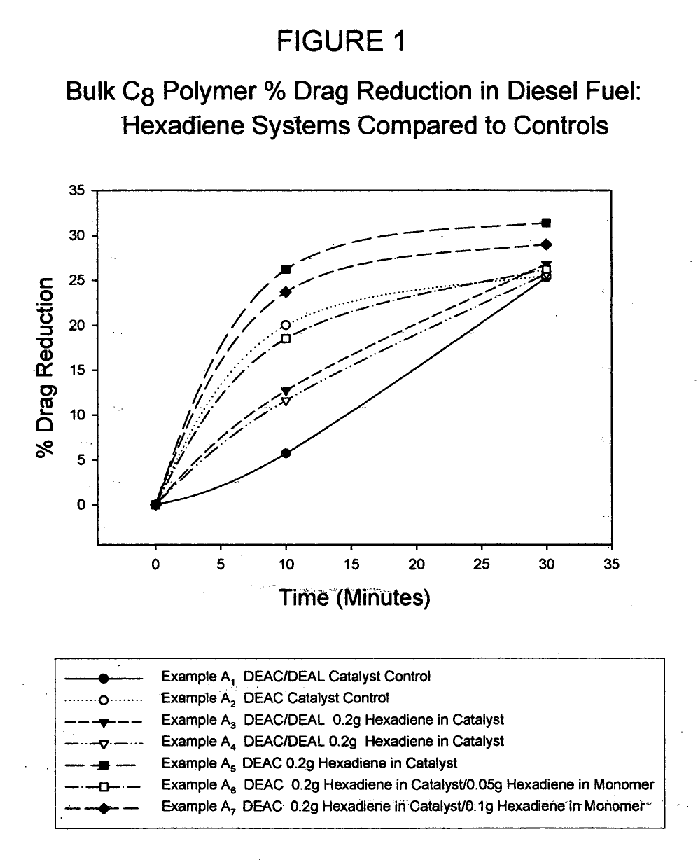

Shown in FIG. 1 is a plot of % drag reduction as a function of time for the dissolution of bulk polymerized octene C8 polymers in diesel hydrocarbon as compared to controls. Efforts were made to manipulate the molecular architecture by the inclusion of a di-unsaturated monomer (1,5-hexadiene) within the bulk polymerization (in various combinations of both catalyst and C8 alpha-olefin monomers). The immediate impact of the experimentation was the enhanced dissolution in diesel fuel of “bulk polymerized” polymer via induced branching that was achieved over the poor dissolving bulk polymer control Example A₁; (Example A₂ being a better performing material with differing alkyl co-cocatalyst) as contrasted with the better performing branched bulk polymer systems. Notice that polymers Example A₅ and Example A₇, as produced by varying combinations of the di-unsaturated monomer in both catalyst and monomer, exhibited increased dissolution over controls. When compared externally to commercially produced FLO® XL solution polymerized polymer, it can be shown that the dissolution profile of the solution polymer is of decreased rate compared to that of either Example A₅ or Example A₇. Also, inherent or maximum drag reduction values of Example A₅ (42.3% drag) and Example A₇ (45.5% drag) were greater than the inherent drag reduction of FLO® XL (36.7% drag). FLO® XL and FLOP XLec drag reducing additives are commercially available from Baker Petrolite.

The data plotted in FIG. 1 coincide with similar dissolution characteristics to that of the “solution polymerized” control polymer (the FLO® XLec control as seen in Table I), where the overall goal is to induce branching to make the bulk polymers perform or dissolve as well as, or even better than, solution polymers in hydrocarbon pipelines; that is, the branched DRA polymers as compared to DRA polymers produced due to solution based-elimination reactions.

TABLE I
% Drag Reduction and Inherent Drag Reduction in Diesel Fuel For
Bulk-Polymerized C8 Polymers Branch-Modified with Hexadiene

| | | % Drag | | | |
|---|---|---|---|---|---|
| | | Reduction | | | |
| | Bulk | (0.28 ppm) | | Inherent Drag Reductions | |
| | Polymer % | 10 min | 30 min | .14 ppm poly | .28 ppm poly |
| Example | Conversion | % DR | % DR | % DR | % DR |
| A₁ | 89.20% | 5.7 | 25.3 | 41.5 | 64.4 |
| A₂ | 92.70% | 20.0 | 25.5 | 24.4 | 41.7 |
| A₃ | 84.40% | 12.7 | 26.8 | 36.3 | 56.9 |
| A₄ | 83.00% | 11.6 | 25.7 | 35.4 | 55.9 |
| A₅ | 64.00% | 26.2 | 31.4 | 26.4 | 42.3 |
| A₆ | 71.30% | 18.5 | 26.2 | 31.2 | 49.1 |
| A₇ | 61.50% | 23.7 | 29.0 | 28.0 | 45.5 |
| XLec | | 20.5 | 28.7 | 20.9 | 36.7 |
| control** | | | | | |

**FLO XLec is a solution polymerized hexene/dodecene copolymer utilized for reference

Another facet of the experimentation is the inclusion of the di-unsaturated monomers in the catalyst preparation itself. Inclusion of the di-unsaturated monomers in the pre-activated Ziegler-Natta catalyst system should generate a star-shaped catalyst species leading to a polymer radiating out (branching out) from the star initiator. When a structure of this nature undergoes shear in a pipeline, the star structure should degrade or lose drag efficiency (gradually decrease in molecular weight with shearing) in a slower fashion as compared to current linear, bulk polymerized polymers).

Thus, for a given linear polymer described by size in solution (again remembering the Rg—radius of gyration), when sheared, the linear polymer chain breaks in half and molecular weight/drag efficiency is decreased accordingly roughly by a factor of 2. However, when a more branched polymer (whether through induced branching, solution polymerization branching, or star catalyst induced branching) is subjected to shear, since the polymer is not linear, the polymer is broken in a fashion such that Rg is not automatically decreased by that factor of 2 as it is in the case of linear polymers. Thus, besides being more readily dissolved and thus becoming effective as a drag reducer more quickly, branched polymers are expected to be more shear tolerant and thus more stable, i.e. able to retain their ability to reduce drag through shearing operations.

### EXAMPLE 2

A manufacturing batch of solution polymerized FLO® XLec was produced as an experimental batch in a 6000 gallon reactor. Instead of utilizing the nominal 14% monomer concentration in the reaction, the reactor was charged with 21% monomer. The resulting FLO® XLec was of higher quality or higher drag reduction value vs. the commercial FLO® XLec and was expected to outperform the typical commercial FLO® XLec. However, subsequent field tests revealed poorer performing dissolution characteristics as compared to traditional solution FLO® XLec. It is believed that when monomer concentrations are increased to larger values (18-24%), the beta-hydride elimination or branching mechanism decreases. Thus, polymer molecular weight and linearity increases and solubility decreases.

### EXAMPLE 3

A reactor combination consisting of a 2 gallon (7.6 liter) continuously stirred tank reactor (CSTR) and a 2″ (5 cm) diameter “Shell and Tube” (S&T) static reactor was used to prepare a number of neat or bulk polymers under standard conditions. Thus, a monomer mixture composed of hexene and dodecene at a known ratio weight ratio (400 grams) was charged into the CSTR and allowed to cool to 25° C. Upon reaching 25° C., a previously prepared catalyst mixture consisting of 0.04 gram 1,5-hexadiene, 0.15 gram of titanium trichloride, 2 grams of aluminum alkyl and 20 grams of mineral oil (Drakeol 34 available from Penreco), was charged to the stirring reactor. This catalyzed mixture was allowed to stir for 5 minutes prior to charging via nitrogen pressure to the static S&T reactor. The mixture was subsequently allowed to polymerize for 24 hours in the S&T reactor at a constantly cooled temperature of 30° C. Upon reaction completion, the solid polymer was collected, granulated via Waring blender and ground to fine particle sizes in a 3″ (7.6 cm) Ross Mega-Shear homogenizer. Dispersing fluids and stabilizing agents were used during the Ross grinding operation, thus the resulting mixture containing 4% polymer was stable for up to one day and could be re-suspended with shaking. Utilizing the standard operating procedures as described above, a number of hexene/dodecene (of a single known ratio) copolymers were prepared containing various quantities of 1,5-hexadiene in the monomer feed. Those polymers and their various properties are shown in the Table II.

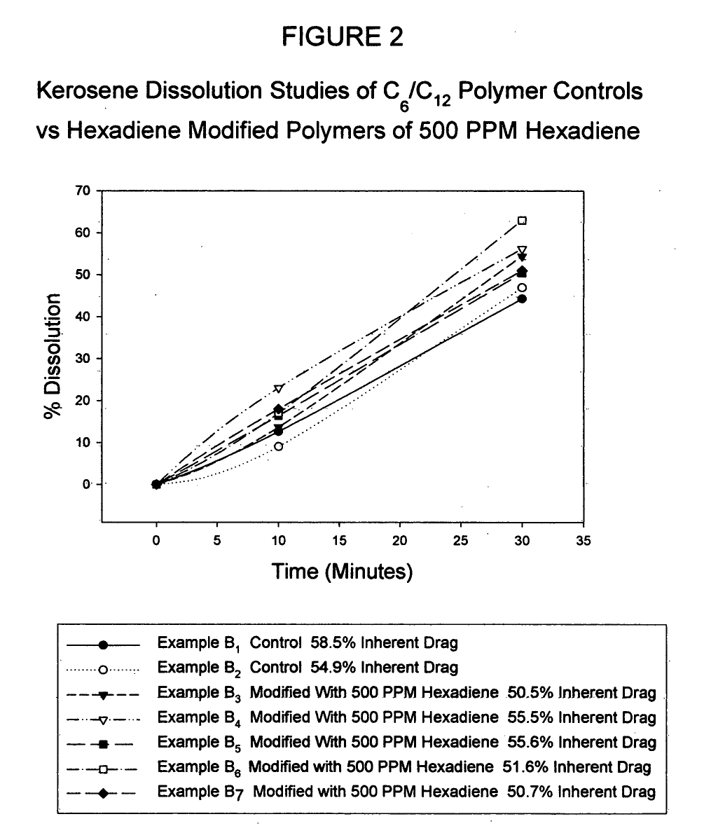

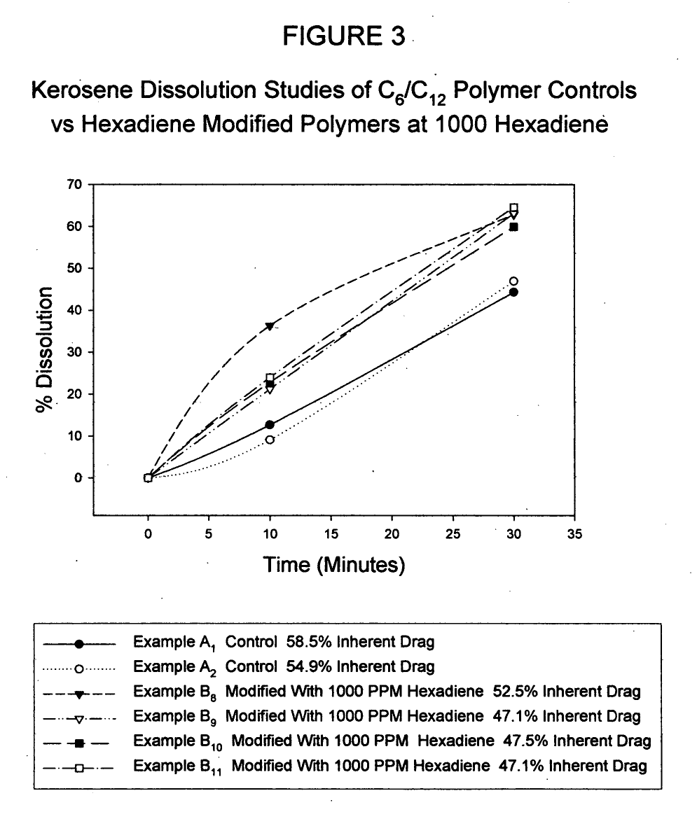

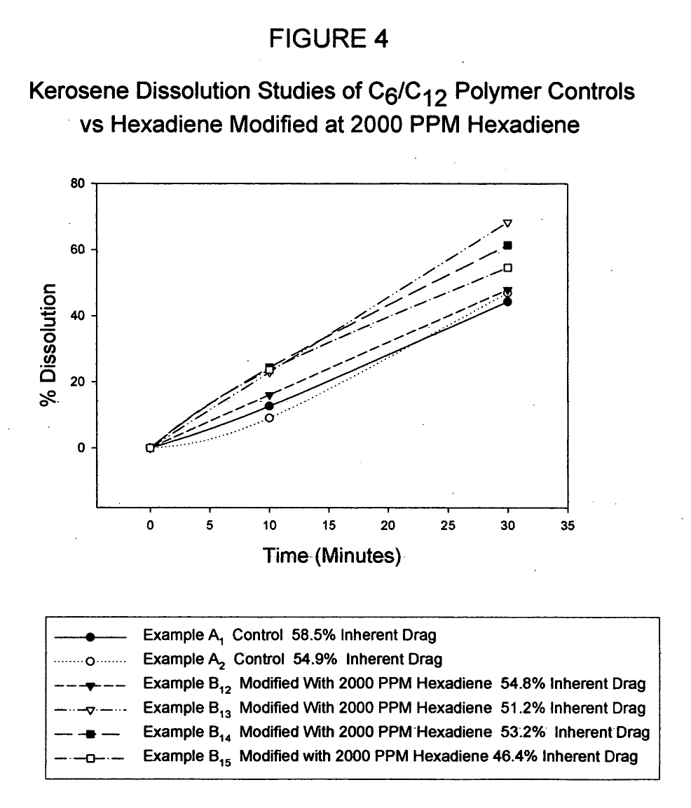

Data from Table 2 is also plotted in FIGS. 2, 3 and 4, all displaying % dissolution of bulk C6/C12 polymers with increasing amounts of 1,5-Hexadiene. Thus, in FIG. 2 polymers modified with 500 ppm of 1,5-hexadiene are shown to display increasing dissolution in kerosene over that of control polymers given approximately similar inherent drag values. This same trend is also shown in FIGS. 3 and 4 corresponding to 1000 ppm and 2000 ppm of 1,5-hexadiene in modified polymers.

TABLE II
Properties of C6/C12 (30/70) Co-polymers via Bulk Polymerization

| | | Monomer | Inherent Drag | | | |
|---|---|---|---|---|---|---|
| | | Feed 1,5- | 0.15 | 0.25 | Kerosene | |
| | | Hexadiene, | ppm | ppm | Dissolution % | |
| Ex. | Conversion | ppm | Polymer | Polymer | 10 min. | 30 min. |
| B₁ | 85.5% | 0 | 39.8 | 58.5 | 12.6% | 44.3% |
| B₂ | 80.0% | 0 | 36.6 | 55.0 | 9.0% | 6.9% |
| B₃ | 85.1% | 500 | 34.5 | 48.7 | 13.7 | 4.4 |
| B₄ | 73.6% | 500 | 35.5 | 55.5 | 23.0% | 61.7% |
| B₅ | 81.6% | 500 | 33.3 | 55.6 | 16.4% | 50.4% |
| B₆ | 74.6% | 500 | 35.8 | 51.6 | 17.0% | 63.0% |
| B₇ | 82.7% | 500 | 31.1 | 47.3 | 23.1% | 64.8% |
| B₈ | 78.9% | 1000 | 29.7 | 52.5 | 36.3% | 62.8% |
| B₉ | 87.8% | 1000 | 25.8 | 37.9 | 21.2% | 63.1% |
| B₁₀ | 85.6% | 1000 | 31.5 | 47.5 | 22.8% | 59.9% |
| B₁₁ | 78.5% | 1000 | 32.8 | 47.1 | 23.9% | 64.6% |
| B₁₂ | 87.2% | 2000 | 39.3 | 54.8 | 16.1% | 47.9% |
| B₁₃ | 65.0% | 2000 | 34.9 | 51.2 | 22.9% | 68.3% |
| B₁₄ | 81.7% | 2000 | 37.1 | 53.2 | 24.3% | 61.4% |
| B₁₅ | 84.7% | 2000 | 33.0 | 46.4 | 23.6% | 54.6% |

### EXAMPLE 4

Utilizing the same reactor combination described in Example 3, several homo-polymers were prepared via bulk polymerization methods. In each case of octene and decene usage, a total weight of 400 grams of monomer was utilized and activated via 0.15 gram of titanium trichloride in combination with 2 grams of aluminum alkyl and 20 grams of mineral oil. There was no pre-activation of the catalyst with 1,5-hexadiene, although 1,5-hexadiene was included in the monomer streams. Control samples were also prepared; the entirety of the data upon similar analysis as above is shown in Table III.

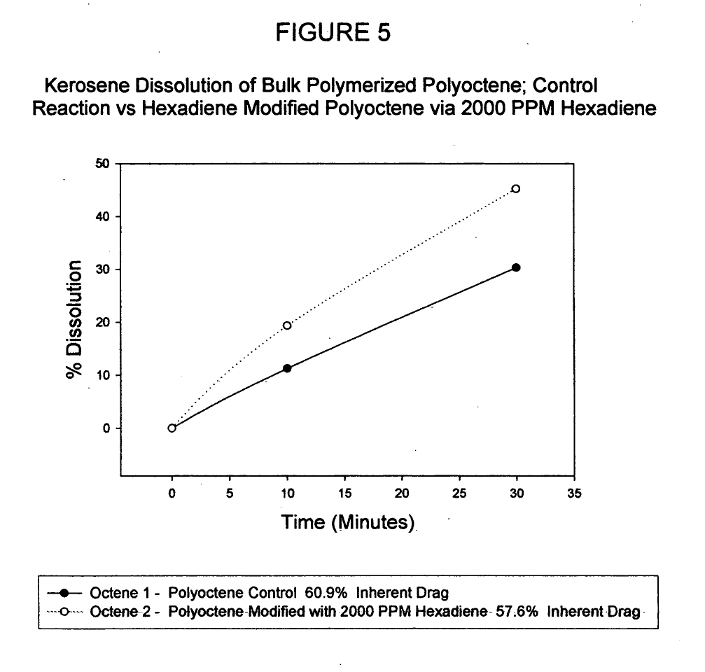

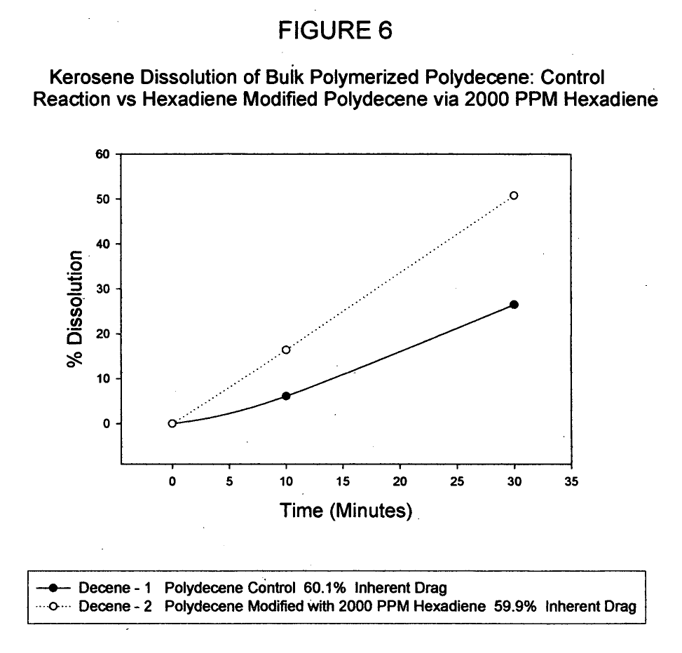

Data from Table III is also plotted in FIGS. 5 and 6 both displaying % dissolution of bulk polymers with 2000 ppm 1,5-hexadiene. Thus, in FIG. 5 a polyoctene polymer modified with 2000 ppm of 1,5-hexadiene is shown to dissolve significantly better in kerosene over that of the control polyoctene at comparable inherent drag values. Also, in FIG. 6 a polydecene polymer modified with 2000 PPM of 1,5-hexadiene is shown to dissolve significantly better in kerosene over that of the control polydecene at comparable inherent drag values.

TABLE III
Properties of Octene and Decene
Homo-Polymers via Bulk Polymerization

| | | | Inherent Drag | | | |
|---|---|---|---|---|---|---|
| | | Monomer | 0.15 | 0.25 | | |
| | Con- | Feed, 1,5- | ppm | ppm | Dissolution | |
| Example | version | Hexadiene | Polymer | Polymer | 10 min. | 30 min. |
| Octene-1 | 89.1% | 0 ppm | 45.2 | 60.9 | 11.3% | 30.4% |
| Octene-2 | 86.1% | 2000 ppm | 41.5 | 57.6 | 19.4% | 45.2% |
| Decene-1 | 77.0% | 0 ppm | 40.7 | 60.1 | 6.1% | 26.5% |
| Decene-2 | 70.0% | 2000 ppm | 42.5 | 59.9 | 16.4% | 50.8% |

Thus, it may be seen that by modifying the molecular structure of a bulk polymer, a drag reducing agent may be provided that dissolves significantly better than that of highly linear DRA polymers after introduction into a hydrocarbon, such as oil flowing through a pipeline. Further, a polymer DRA may be produced that has sufficient molecular branching that improves its dissolution and subsequent mixing; and thereby performance in a flowing hydrocarbon stream. It has been further shown that a bulk polymer DRA may be created having suitable molecular structure that improves resistance to shear forces relative to traditional bulk DRA polymers. Also, a bulk polymer DRA having sufficient induced H-branching to improve dissolution in a hydrocarbon fluid may be continuously produced.

Many modifications may be made in the compositions and methods of this invention without departing from the spirit and scope thereof that are defined only in the appended claims. For example, the exact nature of and proportions of monomer and catalyst, reaction conditions, monomer concentrations and solvents, nature and concentration of di-unsaturated monomers, etc. may be different from those used and explicitly described here. Particular polymerization techniques may be developed to optimize branching types and proportions as well as molecular weights, yet still be within the scope of the invention. Additionally, it will be appreciated that proportions and types of the various DRAs and other components are expected to be optimized for each application or pipeline.

What is claimed is:

1. A process for forming polymer drag reducing agents (DRAs) having improved dissolution in a hydrocarbon, comprising:
polymerizing an alpha-olefin monomer in the presence of a catalyst to form a polymer DRA; and
introducing branching into the polymer DRA during polymerization by a technique selected from the group consisting of:
increasing beta-hydride elimination by a method selected from the group consisting of
decreasing monomer concentration;
increasing polymerization temperature; and
a combination thereof;
incorporating a di-unsaturated monomer with the alpha-olefin monomer;
incorporating a catalyst that causes branching; and
a combination of these techniques.

2. The process of claim 1 where monomer concentration is decreased by incorporating a solvent.

3. The process of claim 1 where the polymerization temperature is increased to between about 4.4 and about 49° C.

4. The process of claim 1 where the di-unsaturated monomer is selected from the group consisting of monomers having at least 2 carbon-carbon unsaturated bonds separated by at least 2 saturated carbon atoms.

5. The process of claim 1 where the di-unsaturated monomer is aliphatic.

6. The process of claim 1 where a branched polymer DRA is formed and the branches have an average chain length of at least 4 carbon atoms.

7. The process of claim 1 where the catalyst that causes branching is selected from the group consisting of Ziegler-Natta catalysts prepared by pre-activating with multi-functional monomers.

8. The process of claim 1 where the branching is long-chain branching defined as Y-branching as a result of Ziegler-Nafta polymerization kinetics.

9. The process of claim 1 where the polymer DRA formed has improved dissolution in a hydrocarbon as compared with a linear poly(alpha-olefin) of identical molecular weight made by an otherwise identical process absent the technique.

10. A process for forming polymer drag reducing agents (DRAs) having improved dissolution in a hydrocarbon, comprising:
polymerizing an alpha-olefin monomer in the presence of a catalyst to form a polymer DRA; and
introducing branching into the polymer DRA during polymerization by a technique selected from the group consisting of:
increasing beta-hydride elimination by a method selected from the group consisting of:
decreasing monomer concentration;
increasing polymerization temperature; and
a combination thereof;
incorporating an aliphatic di-unsaturated monomer with the alpha-olefin monomer;
incorporating a catalyst that causes branching; and
a combination of these techniques,
where a branched polymer DRA is formed and the branches have an average chain length of at least 4 carbon atoms.

11. The process of claim 10 where the branched polymer DRA formed has improved dissolution in a hydrocarbon as compared with a linear poly(alpha-olefin) of identical molecular weight made by an otherwise identical process absent the technique.

12. A poly(alpha-olefin) drag reducing agent (DRA) containing long-chain branching, the DRA having improved dissolution in a hydrocarbon as compared with a linear poly(alpha-olefin) DRA of identical molecular weight absent the branches, where the branches are selected from the group consisting of long-chain Y-branching, induced H-branching and a combination thereof.

13. The poly(alpha-olefin) DRA of claim 12 made by a process comprising:
polymerizing an alpha-olefin monomer in the presence of a catalyst to form a polymer DRA; and
introducing branching into the polymer DRA during polymerization by a technique selected from the group consisting of:
increasing beta-hydride elimination by a method selected from the group consisting of:
decreasing monomer concentration;
increasing polymerization temperature; and
a combination thereof;
incorporating a di-unsaturated monomer with the alpha-olefin monomer;
incorporating a catalyst that causes branching; and
a combination of these techniques.

14. The poly(alpha-olefin) DRA of claim 13 where monomer concentration is decreased by incorporating a solvent.

15. The poly(alpha-olefin) DRA of claim 13 where the polymerization temperature is increased to between about 4.4 and about 49° C.

16. The poly(alpha-olefin) DRA of claim 13 where a branched polymer DRA is formed and the branches have an average chain length of at least 4 carbon atoms.

17. The poly(alpha-olefin) DRA of claim 13 where the di-unsaturated monomer is selected from the group consisting of monomers having at least 2 carbon-carbon unsaturated bonds separated by at least 2 saturated carbon atoms.

18. The poly(alpha-olefin) DRA of claim 13 where the catalyst that causes branching is selected from the group consisting of Ziegler-Natta catalysts prepared by pre-activating with multi-functional monomers.

19. A poly(alpha-olefin) drag reducing agent (DRA) containing long-chain branching, the DRA having improved dissolution in a hydrocarbon as compared with a linear poly(alpha-olefin) DRA of identical molecular weight absent the branches, where the branches are selected from the group consisting of long-chain Y-branching, induced H-branching and a combination thereof; where the poly(alpha-olefin) DRA is made by a process comprising:
polymerizing an alpha-olefin monomer in the presence of a catalyst to form a polymer DRA; and
introducing branching into the polymer DRA during polymerization by a technique selected from the group consisting of:
increasing beta-hydride elimination by a method selected from the group consisting of:
decreasing monomer concentration by incorporating a solvent;
increasing polymerization temperature to between about 4.4 and about 49° C.; and
a combination thereof;
incorporating a di-unsaturated monomer with the alpha-olefin monomer;
incorporating a catalyst that causes branching, where the catalyst is selected from the group consisting of Ziegler-Natta catalysts prepared by pre-activating with multi-functional monomers; and
a combination of these techniques,
where a branched polymer DRA is formed and the branches have an average chain length of at least 4 carbon atoms.

20. A fluid having reduced drag comprising:
a hydrocarbon fluid, and
a poly(alpha-olefin) drag reducing agent (DRA) with long-chain branching where the branching is selected from the group consisting of long-chain Y-branching, induced H-branching, and a combination thereof.

21. The fluid of claim 20 where the poly(alpha-olefin) DRA has branches and the branches have an average chain length of at least 4 carbon atoms.

22. The fluid of claim 20 where the poly(alpha-olefin) DRA has improved dissolution in the hydrocarbon fluid as compared with a linear poly(alpha-olefin) drag reducing agent of identical molecular weight absent the branches.

23. The fluid of claim 20 where the poly(alpha-olefin) DRA is made by a process for comprising:
polymerizing an alpha-olefin monomer in the presence of a catalyst to form a polymer DRA; and
introducing branching into the polymer DRA during polymerization by a technique selected from the group consisting of:
increasing beta-hydride elimination by a method selected from the
decreasing monomer concentration;
increasing polymerization temperature; and
a combination thereof;
incorporating a di-unsaturated monomer with the alpha-olefin monomer;
incorporating a catalyst that causes branching; and
a combination of these techniques.

24. The fluid of claim 23 where monomer concentration is decreased by incorporating a solvent.

25. The fluid of claim 23 where the polymerization temperature is increased to between about 4.4 and about 49° C.

26. The fluid of claim 23 where the di-unsaturated monomer is selected from the group consisting of monomers having at least 2 carbon-carbon unsaturated bonds separated by at least 2 saturated carbon atoms.

27. The fluid of claim 23 where the di-unsaturated monomer is aliphatic.

28. The fluid of 23 where the catalyst that causes branching is selected from the group consisting of Ziegler-Natta catalysts prepared by pre-activating with multifunctional monomers.

29. A fluid having reduced drag comprising:
a hydrocarbon fluid, and
a poly(alpha-olefin) drag reducing agent (DRA) with long-chain branching where the branching is selected from the group consisting of long-chain Y-branching, induced H-branching, and a combination thereof,
where the poly(alpha-olefin) DRA has branches and the branches have an average chain length of at least 4 carbon atoms, and has improved dissolution in the hydrocarbon fluid as compared with a linear poly(alpha-olefin) drag reducing agent of identical molecular weight absent the branches.

30. The fluid of claim 29 where the poly(alpha-olefin) DRA is made by a process for comprising:
polymerizing an alpha-olefin monomer in the presence of a catalyst to form a polymer DRA; and
introducing branching into the polymer DRA during polymerization by a technique selected from the group consisting of:
increasing beta-hydride elimination by a method selected from the group consisting of:
decreasing monomer concentration by incorporating a solvent;
increasing polymerization temperature to between about 4.4 and about 49° C.; and
a combination thereof;
incorporating an aliphatic di-unsaturated monomer with the alpha-olefin monomer;
incorporating a catalyst that causes branching where the catalyst is selected from the group consisting of Ziegler-Natta catalysts prepared by pre-activating with multi-functional monomers; and
a combination of these techniques.
